(19) United States
(12) Patent Application Publication
(10) Pub. No.: US 2025/0089126 A1
(43) Pub. Date: Mar. 13, 2025

(54) COMMUNICATIONS MODULES AND COMMUNICATION SYSTEMS INCLUDING THE SAME

(71) Applicant: St. Anthony, LLC, Payson, UT (US)

(72) Inventors: Kevin W. Sorensen, Spanish Fork, UT (US); Eric B. Nelson, Santaquin, UT (US); William Herbert Darden, IV, Cary, NC (US); Bradley B. Bakke, Huntley, IL (US); Jeffrey Alfred Lick, Beaufort, NC (US); Victoria Francesca B. Kull, Palatine, IL (US); Andrew Alden Spear, Raleigh, NC (US)

(21) Appl. No.: 18/827,664

(22) Filed: Sep. 6, 2024

Related U.S. Application Data
(60) Provisional application No. 63/537,471, filed on Sep. 8, 2023.
(60) Provisional application No. 63/605,287, filed on Dec. 1, 2023.

(51) Int. Cl. H04W 76/45; H04L 5/14; H04W 76/10

(52) U.S. Cl. CPC H04W 76/45; H04L 5/14; H04W 76/10

(57) ABSTRACT

A communications module for facilitating mobile wireless communication, the communications module including a transceiver configured to enable wireless communication, a processor communicatively coupled to the transceiver, a mode switch configured to change an operating setting of the communications module between a first mode and a second mode. In the first mode, the transceiver communicates with a central communications unit, and in the second mode, the transceiver communicates with a corresponding communications module.

### CROSS-REFERENCE TO RELATED APPLICATION(S)

This application claims priority to U.S. Provisional Patent Application No. 63/537,471, filed 8 Sep. 2023, and entitled “COMMUNICATIONS MODULES AND COMMUNICATION SYSTEMS INCLUDING THE SAME”, and also claims priority to U.S. Provisional Patent Application No. 63/605,287, filed 1 Dec. 2023, and entitled “COMMUNICATIONS MODULES AND COMMUNICATION SYSTEMS INCLUDING THE SAME”, the entire disclosures of which are hereby incorporated by reference.

### FIELD

The described embodiments relate generally to wireless communications and, more specifically, to helmet or headset mounted communications modules and network systems that are useful for mobile activities involving multiple users and multiple groups. This disclosure further relates to protocols and systems for sharing audio content between multiple users.

### BACKGROUND

Group vehicle activities, such as off-roading activities that involve multiple people are enhanced by communication between participants. However, communication during riding activities, whether on-road or off-road, can be difficult due to high noise levels, headgear covering the ears, and potentially large distances between participants, especially when multiple vehicles are involved in such activities. Such communication needs and difficulties can apply to a number of situations, such as off-roading, on-road travel, cycling, mountain biking, hiking, team sports, construction sites, large workplaces, first responders situations, etc. Further such communication needs can arise when using a variety of vehicles (e.g., utility terrain vehicles (UTVs), all-terrain vehicles (ATVs), street motorcycles, dirt bikes, etc.).

Radios, such as walkie-talkies and similar communication devices are often used to facilitate communication during such activities. However, conventional communication devices have limited functionality and can be cumbersome to operate. Moreover, most walkie-talkies are half-duplex, meaning that they are incapable of simultaneously receiving audio input and providing audio output. The user of a walkie-talkie cannot speak and listen to others at the same time. Thus, while walkie-talkies and similar communication devices can enhance communication between participants during group activities, the extent to which they enhance communication is limited.

Short range radio communication protocols, such as Bluetooth®, have further improved group communication by allowing for full-duplex communication between group members. Full-duplex communication devices enables a user to speak and be heard by others while simultaneously hearing other users. While Bluetooth devices can enhance communication between participants during mobile group activities, they also limit the extent to which the participants may communicate with each other. The real-world range of most Bluetooth devices in providing reliable communications is currently limited to about a half a mile (about 0.8 km). Further, conventional devices fail to provide dynamic communications for a wide range of situations and needs.

Thus, while long-range radios and short-range Bluetooth devices each can contribute to the experience, they each include limitations that prevent the technologies from meeting the needs of the users. Furthermore, conventional short-range and long-range methods of communication fail to integrate in a way that would allow the user dual functionality of both short and long range communication means.

### SUMMARY

According to some aspects of the present disclosure, a communications module for facilitating mobile wireless communication can include a transceiver that can enable wireless communication, a processor communicatively coupled to the transceiver, a mode switch that can change an operating setting of the communications module between a first mode and a second mode. In the first mode, the transceiver can communicate with a central communications unit. In the second mode, the transceiver can communicate with a corresponding communications module.

In some examples, the mode switch can be selectable by a user. The communications modules can include an input member to enable audio signals from the communications module to be transmitted through an auxiliary radio. The auxiliary radio can be communicatively coupled to the central communications unit. The audio signals can be transmitted through the central communications unit to the auxiliary radio. The transceiver can receive transmissions from the auxiliary radio through the central communications unit. In the first mode, the communications module can simultaneously communicate with the corresponding communications module and with the auxiliary radio.

In some examples, the communications module can include a push-to-talk (PTT button) to transmit audio output from a microphone connected to the communications module through an auxiliary radio. The first mode can enable full-duplex communication between the communications module and the central communications unit. The second mode can enable full-duplex communication between the communications module and the corresponding communications module.

In some examples, in the first mode, the transceiver can operate at a first power. In the second mode, the transceiver can operate at a second power. The second power can be greater than the first power. The transceiver can be a first transceiver, the communications module can include a second transceiver to establish wireless communication with a mobile electronic device. The first transceiver can operate according to Bluetooth LE, and the second transceiver can operate according to Bluetooth classic.

According to some aspects, a communication system can include a central hub that can communicatively couple with an auxiliary radio capable of long range two-way communication, and a first mobile intercom carried by a first user. The first mobile intercom can include a first output terminal that can connect to a first speaker, a first input terminal to connect to a first microphone, a first wireless communications unit to establish wireless communication between the first mobile intercom and the central hub, and a first input member to receive user input. The communication system can include a second mobile intercom to be carried by a second user. The second mobile intercom can include a second output terminal to connect to a second speaker, a second input terminal to connect to a second microphone, a second wireless communications unit to establish wireless communication between the second mobile intercom and the central hub, and a second input member to receive user input. In response to receiving user input at the first input member, the central hub can transmit audio signals received by the first microphone and the second microphone through the auxiliary radio.

In some examples, the first input member can include push-to-talk (PTT) functionality. The audio signals received by the first microphone or the second microphone can be transmitted through the auxiliary radio while the first input member is actuated. In some examples, the central hub can communicatively couple with a plurality of mobile intercoms, transmit audio output from the auxiliary radio to each of the plurality of mobile intercoms, and in response to receiving user input at the first input member, transmit audio input from each of the plurality of intercoms through the auxiliary radio.

In some examples, the central hub can prioritize audio signals from the auxiliary radio over audio content from a personal electronic device paired with the first mobile intercom. The first mobile intercom can prioritize audio from a telephone call from a paired personal electronic device over audio from the auxiliary radio.

According to some aspects, a mobile communication system can include a first intercom device carried by a first user, a second intercom device carried by a second user, and a base station. The base station can include a wireless communications unit that can establish a wireless connection with an electronic device and enable full-duplex communication between the first intercom device and the second intercom device. The base station can share audio content from the electronic device with the first intercom device and the second intercom device while maintaining the full-duplex communication between the first intercom device and the second intercom device.

In some examples, the wireless communications unit can include a first wireless communications chip to enable wireless communication with the first intercom device and the second intercom device, and a second wireless communications chip to enable wireless communication between the base station and the electronic device.

In some examples, the electronic device can be a first electronic device, and the second intercom device can wirelessly pair with a second electronic device and can prioritize audio content from the second electronic device over audio content from the first electronic device. The second intercom device can prioritize audio signals transmitted through the base station from the first intercom device over audio content from the second electronic device.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a schematic block diagram of select components of a communications module;

FIG. 2 shows a schematic block diagram for a communications network system according to a first mode;

FIG. 3 shows a schematic block diagram of select components of a central communications hub;

FIG. 4A shows a schematic block diagram for a communications network system according to a second mode;

FIG. 4B shows a schematic block diagram for a communications network system according to the second mode;

FIG. 4C shows a schematic block diagram for a communications network system according to the second mode;

FIG. 5 shows a schematic block diagram for a communications network involving multiple groups.

FIG. 6 shows a process flow diagram of an example process for forming a wireless communications network; and

FIG. 7 shows a process flow diagram of an example priority protocol for audio content in a group communications system.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

In some examples, a communications module is disclosed. The communications module can be referred to as a module, intercom, device, headphone, headset, etc. It will be understood that, as used herein, “module” refers to at least a radio transceiver capable of wireless communication and inputting and outputting audio data. In some examples, the communications module can mount or attach to headgear worn by a user, such as a helmet or aviation style headset. As discussed herein, the communications module can enable full-duplex communication capable of being supplemented with long-range radio communication and shared audio content capabilities.

The module further includes multiple modes with features and functionality for different scenarios. For example, the module may include a first mode and a second mode. The first mode may be ideal for short-range communication when the users of the group are close in proximity. However, when the distances between users increase, the first mode may be insufficient for ideal communication. The second mode can accommodate for long-range communication at a relatively high power and can establish full-duplex communication between different modules that are separated by large distances, such as between occupants of different vehicles (e.g., riders of separate motorcycles or occupants of different UTVs).

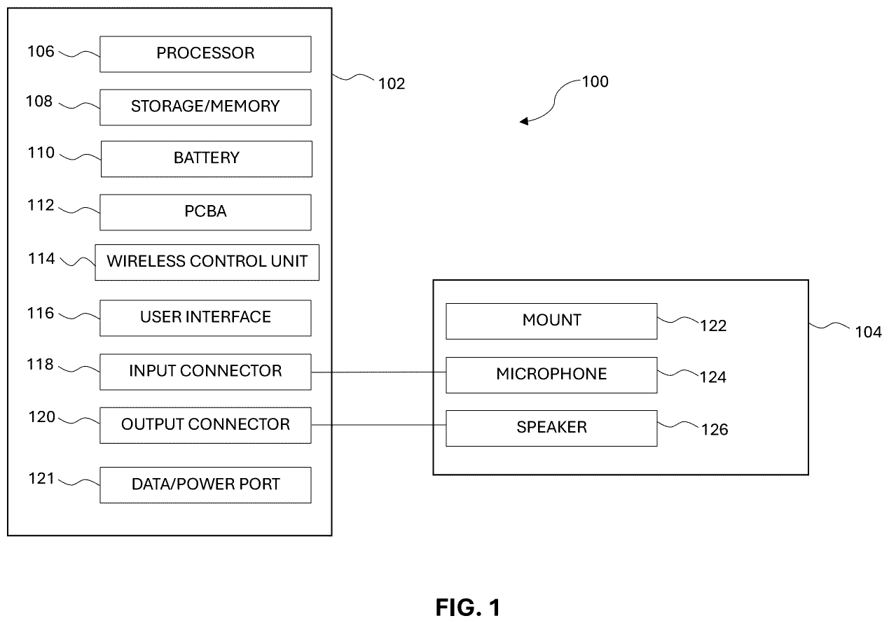

These and other embodiments are discussed below with reference to FIGS. 1-8. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a non-limiting example of select components of a communication system 100. The communication system 100 can include a wireless communications module 102 (also referred to herein as “module” or “intercom”) that is attachable to headgear 104, such as a headset or helmet. The module 102 can include a housing to contain a number of electronic components. In some examples, the module 102 can include a controller or processor 106, storage/memory 108, a battery 110, a printed circuit board assembly (PCBA) 112, a wireless control unit 114, a user interface 116, an input connector 118, an output connector 120, and a data/power port 121. The data/power port 121 can be an electrical port for receiving data and/or power (e.g., through a USB connection). The port 121 can be used to charge the module 102 and receive software updates. It will be understood that this is not an exhaustive list of the components of the module 102. It will further be understood that it is not required for the module 102 to include all of the components identified in FIG. 1.

The module 102 can include control circuitry and may include storage and processing circuitry, such as processor 106 and storage/memory 108, for controlling the operation of the module 102. The storage/memory 108 can include hard disk drive storage, nonvolatile memory (e.g., electrically-programmable-read-only memory configured to form a solid-state drive), volatile memory (e.g., static or dynamic random-access-memory), etc. The processor 106 can include one or more microprocessors, microcontrollers, digital signal processors, baseband processors, power management units, audio chips, application specific integrated circuits, and other integrated circuits. Software code may be stored on the storage/memory 108 and run on processor 106 to implement control operations for the module 102.

The wireless control unit 114 can include one or more radio-frequency transceivers for establishing wireless communication with other devices. The wireless control unit 114 can include one or more of a Bluetooth classic or Bluetooth Low Energy chip or any other suitable wireless communication device or protocol. The wireless control unit 114 can be used to establish a wireless connection between the module 102 and one or more wireless communications modules, central hubs, mobile electronic devices, smart devices, GPS units, or any other electronic device capable of establish a wireless connection.

In some examples, the wireless control unit 114 includes multiple wireless communications chips. For instance, the module 102 can include a first wireless communications chip configured to enable wireless communication between a corresponding module and/or a central base station, and a second wireless communications chip configured to enable wireless communication with a personal electronic device, such as a smartphone. The first wireless communication chip can operate according to Bluetooth Low Energy (LE) (which can include LE Audio). The second wireless communication chip can operate according to Bluetooth classic. In some examples, both wireless communications chips operate according to Bluetooth LE. In some examples, the wireless control unit 114 includes only one wireless communications chip that runs Bluetooth LE. The wireless control unit 114 can include one or more antennas for transmission and reception of radio waves. The antennas can include low gain antennas. In some examples, the first wireless communications chip is operatively coupled to a first antenna, and the second wireless communications chip is operatively coupled to a second antenna.

The user interface 116 can include one or more input members for receiving user input. In some examples, the user interface 116 includes one or more buttons that are accessible from an exterior of the housing of the module 102. The input members can include one or more of push buttons, switches, slider switches, rocker switches, tabs, crowns, dials, touch sensors, pressure sensors, light sensors, tactile sensors, audio sensors, or any other suitable mechanism for receiving user input or controls.

In some examples, the user interface 116 can include power or on/off controls, push-to-talk (“PTT”) controls, phone controls, music controls, wireless pairing controls, volume controls, mute controls, mode controls, etc. In some examples, the same input member can be responsible for multiple different functions or controls. For example, a certain press duration or a certain combination of the buttons may be used for certain functions.

The user interface 116 of the module 102 can include a mute function to stop transmission of audio signals from and/or to the module 102. In some examples, when muted, the user cannot hear other users of paired devices, and the user cannot be heard by the other paired devices. In some examples, a muted user can still hear other connected users, but the muted user cannot be heard by the others. The mute button can turn off, block, or disable the microphone and/or speakers of the module 102, while the connection between the paired devices is maintained.

The user interface 116 can include one or more outputs that are intended to communicate to the user a status of the module 102. In some examples, the module 102 can include a display visible on an exterior of the module 102. The module 102 can include one or more visual, audible, or tactile indicators intended to communicate or provide feedback to the user.

The module 102 can include an input connector 118 and an output connector 120. The input connector 118 and the output connector 120 can include electrical contacts or terminals of a known type that are configured to establish an electrical connection with corresponding connectors on headgear 104. For example, when the module 102 is attached to the headgear 104 using the mount 122, the input connector 118 can be electrically and communicatively coupled with a microphone 124 of the headgear 104, and the output connector 120 can be electrically and communicatively coupled with a speaker 126 of the headgear 104. In some examples, the module 102 can include a 12-pin connector. The input connector 118 and the output connector 120 can be incorporated into the 12-pin connector. The 12-pin connector can mate with a corresponding connector included in the headgear mount 122. The mount 122 can provide electrical access to the microphone 124 and the speaker 126 attached to the headgear 104.

The module 102 can be carried on the person of the user. For instance, the module 102 can be removably attached to headgear 104, such as a helmet or a headset worn by the user. The headgear 104 can include or be modified to include a mount 122, a microphone 124, and a speaker 126. In some examples, the headgear 104 is manufactured with the mount 122, microphone 124, and speaker integrated into the headgear 104 as built-in features. The mount 122 can be referred to as a cradle or attachment mechanism. The mount 122 can include a surface, such as a back surface that is configured to affix or adhere to an exterior of the headgear 104. The mount 122 can include an attachment mechanism to retain the module 102. Thus, in some examples, the module 102 can be releasably attached to the headgear 104 by means of the mount 122. The mount 122 can include electrical connectors or terminals positioned to contact and establish an electrical connection with corresponding input and output connectors 118, 120 of the module 102.

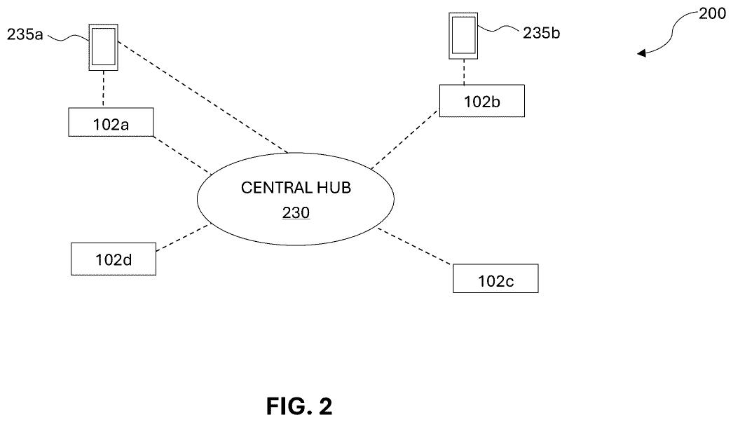

FIG. 2 illustrates a wireless communication system 200 operating in a first mode or first setting. The system 200 can include a central hub 230 (also referred to as central communications unit, base station, or simply “hub”) that is configured to be wirelessly connected to a plurality of modules 102a-102d (individually referred to as “module 102” and collectively referred to as “modules 102”). It will be understood that while features may be described as applying to the modules, as a collective, the described features are included in each module, individually and independent of the other modules. Each of the modules 102 can be substantially similar to and can include some or all of the features of the module 102 described above with reference to FIG. 1.

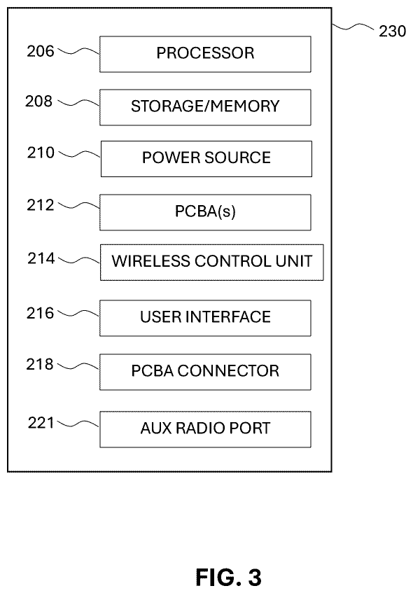

The central hub 230 can be permanently or removably fixed to a vehicle (e.g., integrated or mounted to a dash of a UTV). In some examples, the central hub 230 can be installed behind a dashboard of a vehicle. The central hub 230 can include some or all of the control circuitry and components of the module 102, as described in FIG. 1, and can include additional componentry as discussed in reference to FIG. 3. The central hub 230 can include processing and wireless communication circuitry to coordinate wireless communication between a plurality of modules 102 and an auxiliary radio, as discussed herein.

FIG. 3 is a block diagram illustrating some of the components of the central hub 230. The central hub 230 can include a controller or processor 206, storage/memory 208, a power source 210, printed circuit board assemblies (PCBAs) 212, a wireless control unit 214, a user interface 216, an PCBA board-to-board connector 218, and an auxiliary radio port 221 for electrically connecting to an auxiliary radio, as discussed in greater detail below. It will be understood that this is not an exhaustive list of the components of the central hub 230. It will further be understood that it is not required for the central hub 230 to include all of the components identified in FIG. 3.

The central hub 230 can include a similar or identical printed circuit board assembly (PCBA) as the module 102. The central hub 230 can further include a second PCBA including a second processor that manages an auxiliary two-way radio. The first PCBA and the second PCBA can mate or couple using a board-to-board connector 218. Accordingly, the central hub 230 can include multiple processors assigned to different tasks.

In some examples, the user interface 216 of the central hub 230 is separated from the main housing of the central hub 230. For example, the primary housing of the central hub 230 can be attached behind the dash of the vehicle, while the user interface 216 can be positioned such that it is accessible to a driver and/or passengers (e.g., on the dash in the location of a rocker switch).

The user interface 216 can include one or more input members or buttons for receiving user input. The input members can include one or more of push buttons, switches, slider switches, rocker switches, tabs, crowns, dials, touch sensors, pressure sensors, light sensors, tactile sensors, audio sensors, or any other suitable mechanism for receiving user input or controls. In some examples, the user interface 116 can include track backward button, a track forward button, a pairing button, a power button, a phone button, etc. The user interface can include a small form factor and can have a minimalistic design with a minimum number of buttons (e.g., five buttons). The central hub 230 can include a display, such as a touch display that the user can interact with. The user interface of the central hub 230 can include feedback, such as LED feedback and status indicators.

The central hub 230 can be capable of communicatively connecting two or more modules 102. In some examples, the central hub 230 can be capable of connecting up to four modules 102 at a time. In some examples, the central hub 230 can be capable of connecting with more than four modules at a time (e.g., six modules at a time). The system 200 can be a hub-and-spoke style communication system.

The central hub 230 can operate using the same software as the modules 102, however the software-to-hardware interface can know which type of device it is operating in, and act differently depending on if it is in the central hub 230 or a module 102.

With reference again to FIG. 2, the system 200 can enable full-duplex communication between the modules 102 through the central hub 230. In some examples, the modules 102 can switch between different modes. The different modes can correspond to different transceiver power settings. As shown in FIG. 2, the modules 102 can include a first operating setting or first mode intended for short-range communication (e.g., for communication of several feet, up to about 300 feet). In the first mode, the modules 102 can be communicatively coupled through the central hub 230 and can operate at a first power. In the first mode, the power level can be about 15 decibel milliwatts (dBm) conducted power, or about 31.6 milli-watts.

Each module 102 can be connected to the central hub 230 via a wireless communication protocol, such as the Bluetooth protocol. For example, the wireless communication between the central hub 230 and the modules 102 can operate in the 2.4 GHz ISM band with a frequency between 2.402 and 2.480 GHz and with frequency hopping to avoid interference. The system 200 can implement one or more of classic Bluetooth or Bluetooth low energy (BLE).

In some examples, the modules 102, when in the first mode, can advertise per the Bluetooth standard in attempts to be discovered by the central hub 230 and initiate a connection. Likewise, the central hub 230, if not connected to the maximum number of modules, can scan, per the Bluetooth standard, to find and initiate connection to additional modules 102. If the central hub 230 is connected to the maximum number of modules, the central hub 230 may stop scanning for additional modules.

Accordingly, short-range communication at a relatively low first power can be used to establish a wireless connection between each module 102 via the central hub 230. Such short-range connections can be suitable for communication between different modules 102 that are in the same general location, such as within the same vehicle (e.g., passengers in the same UTV) or who are in relatively close proximity to each other.

In some examples, two or more modules 102 can be directly communicatively coupled while in the first mode (i.e., at the first power) without relaying the signals through the central hub 230, for example, when a central hub 230 is disabled or not available or when two or more modules desire to establish a private conversation separate from the other modules connected to the central hub 230. Such private channels can also be managed through the central hub 230. The first mode can be selected in order to reduce battery consumption and prolong battery life.

The central hub 230 can have complete control over the timing of the network in order to schedule time to broadcast audio content and use the remaining time to interleave the channel broadcasts from the modules 102 and/or from an auxiliary radio. In the first mode, the central hub 230 can control the entire system unit timing. However, as will be discussed in greater detail below, in the second mode there is no central control and so, to overcome timing collisions, the module-to-modules connections are limited to a lesser number than the central hub's limit of connections. For example, the central hub 230 may be limited to four module connections while modules in the second mode may be limited to three module connections, and the remaining capacity is available for retransmissions when there are communication collisions.

The modules 102 can be capable of pairing with multiple wireless devices (e.g., multiple Bluetooth devices). The modules 102 can pair with personal mobile electronic devices, smartphones, auxiliary radios, GPS receivers, wearable devices, smartwatches, head-mounted display devices, smart glasses, etc. As illustrated in FIG. 2, a first module 102a can be paired with a first electronic device 235a, and a second module 102b can be paired with a second electronic device 235b. Thus, the modules 102a, 102b can be simultaneously paired with the central hub 230 and with a separate electronic device 235a, 235b, respectively. For clarity, FIG. 2 only illustrates two of the modules 102a, 102b paired to additional devices, however, it will be understood that in some examples, all of the modules paired with the central hub 230 can also be simultaneously paired with one or more separate personal electronic devices. In some examples, the modules 102 can pair with two personal electronic devices while simultaneously being paired with the central hub 230 or with other modules in the second mode.

While the first module 102a is paired with the first electronic device 235a, the first module 102a can access at least some of the functionality and features of the first electronic device 235a. For instance, in an example where the first electronic device 235a is a smartphone, the first module 102a can make and receive phone calls from the first electronic device 235a. The first module 102a can receive speech by a microphone connected to the first module 102a and transmit the input to the first electronic device 235a. Likewise, the first module 102a can receive output from the first electronic device 235a and emit the output through one or more speakers connected to the first module 102a. In some examples, music or other media from the first electronic device 235a can be provided to the first module 102a. In some examples, the first electronic device 235a can receive smart assistant instructions or requests (e.g., “hey Siri,” “Alexa,” etc.) through the microphone of the first module 102a. As discussed in greater detail herein, the second module 102b can receive media from the first electronic device 102a, facilitated through the central hub 230.

In some examples, the electronic devices can be smartphones configured to download a software program or application that includes specific functions or services specific to operation of the modules 102 and/or central hub 230. The software application can provide the user with an interface on their phone to interact with and control the modules 102 and/or central hub 230.

The software application on a smartphone can leverage Wi-Fi, cellular, Bluetooth, or other networks to facilitate communication with the module. The app can be integrated with the module's hardware through a dedicated application programming interface (API). The app can provide users with specific functionalities or services directly through their personal device. The app can operate by interacting with the smartphone's operating system and hardware, utilizing features such as touchscreens, cameras, and sensors of the device. The app can communicate with servers or other systems over the internet to fetch or send data. In some examples, the user interface of the app can include some or all of the features of the module's user interface. In other words, instead of using the physical buttons located on the module itself, a user can access the same functionality and inputs through the app. The software application may offer real-time status updates and control over various settings.

In some examples, the software application can be used to customize the communication network between modules. For example, a user can, via the app, set up private channels, customize shared media content, set parameters or controls of one or more modules, change operating settings of the central hub and/or of the modules, interface with an auxiliary radio, etc.

The central hub 230 can wirelessly pair directly with an electronic device. For example, the first electronic device 235a can establish a wireless connection (e.g., through Bluetooth classic) with the central hub 230. Music or other media from the first electronic device 235a can then be shared with all of the connected modules 102a-102d through the central hub 230. In some examples, only one personal electronic device can be paired to the central hub 230 at a time. For example, while the first electronic device 235a is paired with the central hub 230, the second electronic device 235b may be unable to pair directly with the central hub 230. In some examples, the central hub 230 can be simultaneously paired with both the first electronic device 235a and the second electronic device 235b. Passthrough can be prioritized by a predetermined pairing sequence. The central hub 230 can include a priority protocol for establishing which electronic device has priority when multiple devices 235a, 235b are connected to the central hub 230. In some examples, priority is given to whichever device was first to connect to the central hub 230. In some examples, priority is given to whichever device 235a, 235b had paired more recently with the central hub 230. In some examples, a user can select which device 235a, 235b connected to the central hub 230 is the main or primary device and can grant priority to that device 235a, 235b.

The system 200 can include functionality that allows audio content (e.g., music) to be shared between users. Each user can play their own music while still being in the group conversation in the first mode. Sharing audio content can be accomplished using Bluetooth LE. Importantly, the present disclosure enables audio content sharing while also maintaining the first mode communications via the central hub 230.

In some examples, a user's smartphone (e.g., first electronic device 235a) can be paired with both the first module 102a and the central hub 230, the user can then select whether the audio content of the first electronic device 235a will be heard by only that user (e.g., sending music from the phone to the module 102a via the Bluetooth classic chip in the module 102a) or whether the music will be heard by all in the group (e.g., sending music from the phone to the central hub 230 via a Bluetooth classic chip, and then transmitting the music from the central hub 230 to all modules paired to the central hub 230 via the Bluetooth LE chips.

In some examples, a module 102 will prioritize audio content from a paired electronic device over audio content shared through the central hub 230. For example, if a first electronic device 235a is sharing music through the central hub 230, the music may be heard by all the modules 102a-102d as a default setting. Supposing the user of a second module 102b wishes to listen to their own music, they can pair their electronic device 235b to their module 102b, at which point, any audio content played on the second electronic device 235b will be output to the second module 102b instead of the music from the central hub 230. Importantly, the modules 102 are able to maintain their first mode communication through the central hub 230 while at the same time enjoying audio content, regardless of whether the audio content is shared or private). The shared media, music, or other audio content can be shared over the BLE Broadcast Audio channel from the central hub.

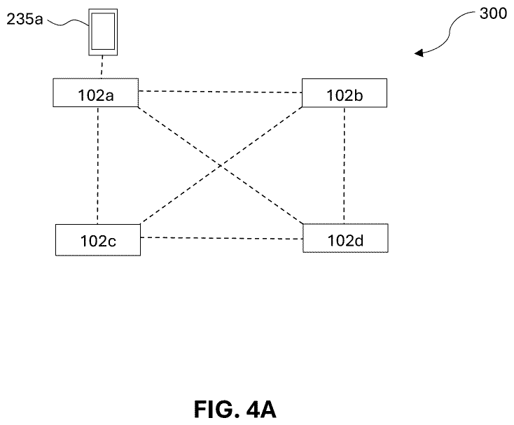

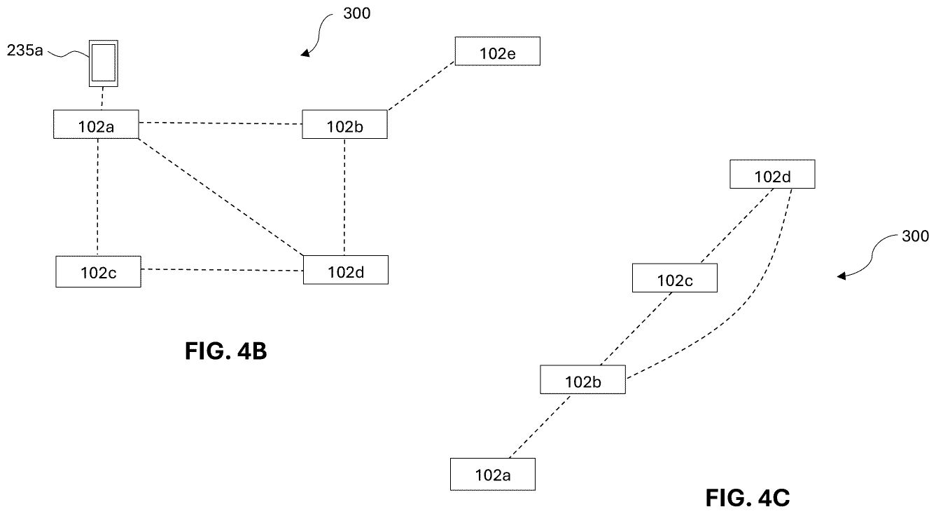

FIGS. 4A-4C show embodiments of communication systems having a plurality of nodes. The nodes can include modules 102 that are worn or otherwise carried by users. The network created by the modules 102 can form mesh network, or more specifically a partially connected mesh network, in which communication occurs directly between modules. The mesh network can be established as a result of the modules 102 being put in the second mode (higher, second power, longer distance setting).

FIG. 4A illustrates a wireless communication system 300 in which a plurality of modules 102a-102d (referred to as “modules 102”) are operating in a second mode, protocol, or setting. The modules 102 can be substantially similar to and can include some or all of the features of the modules 102 described above with respect to FIGS. 1 and 2. The system 300 can provide for full-duplex communication directly between two or more modules 102. In some examples, each module 102 can be configured to pair or connect with up to three other modules while in the second mode. For example, a first module 102a can be simultaneously communicatively coupled with three other modules, 102b, 102c, and 102d. It will be understood that, in some cases, a first module 102a may connect with more than three other modules, depending on capacity. In some examples, the system 300 can accommodate up to 15 users communicatively coupled in a full-duplex mesh connection.

The second mode can be intended for long-range communication (e.g., up to several miles). The second mode can be used for establishing communication between two or more modules 102 that are too far away from each other to effectively connect in the first mode. The second mode can also be used to establish communication between two or more modules 102 that are close in proximity (e.g., within the range of the first mode), but which do not have access to a central hub to facilitate first mode communication.

When switching between modes, the module 102 changes the radio-frequency power levels to adapt to the antenna operating environment for the different modes. In the second mode, the modules 102 can operate at a second power that is higher than the first power of the first mode. The power levels in first and second mode can be configurable. The first mode can have a free space range of about 100 yards and the second mode can have a free space range of about 0.5 mile. In the second mode, the power level can be increased to about 20 decibel milliwatts (dBm) conducted power, or about 100 milliwatts.

In the second mode, each module 102 can be wirelessly communicatively coupled directly to one or more other modules 102 that are also in the second mode. In the second mode, the modules 102 may not be connected through a central hub. Instead, in the second mode, the modules 102 can be connected in a self-healing mesh-style network. In some examples, the modules 102 can be communicatively coupled to the central hub 230 while in the second, higher power mode (i.e., the central hub 230 may also include multi-mode functionality that allows it to operate at different power levels). In some examples, in the first mode of operation, there are different user settable power levels to achieve different ranges.

The module 102 operating in the second mode still has the capability of connecting to another electronic device. As illustrated in FIG. 4A, the first module 102a can wirelessly connect to the first electronic device 235a while also maintaining a connection with the other modules 102b-102d.

FIG. 4B illustrates the system 300 as a network of modules 102 operating in the second mode. As described herein, each module 102 may have a limited connection capacity to connect with other modules 102 in the second mode. For example, each module 102 may only be able to connect to up to three other modules 102 (as represented in FIG. 4A). Despite having the maximum number of connections, the modules 102 will continue to scan and advertise in attempts to find other modules that should be in the group.

FIG. 4A shows an example of when the maximum number of connections is three. The module 102b is maxed out, being connected to three other modules 102a, 102c, and 102d. As represented in FIG. 4B, when a new module 102e comes within range of the network, one or more of the modules can disconnect from one or more of the other modules in order to create a free slot to connect to the new module 102e. As illustrated, module 102b disconnects from module 102c in order to be able to connect with module 102e. In this manner, the modules 102 in the second mode can establish a self-healing mesh style network. In some examples, before the module 102b breaks its connection with module 102c, the module 102b verifies from its group list that the module 102c is connected to at least one other module. This ensures that when the module 102b breaks its connection with the module 102c, the module 102c is not dropped completely out of the network. In the case in which the module 102c was only connected to the module 102b, the module 102b would then move to a different module (e.g., module 102a or module 102d) in the network to consider breaking those connections instead.

FIG. 4C illustrates another embodiment of the system 300. In some examples, the modules 102 can communicate directly with each other in a daisy chain fashion. As shown in FIG. 4C, the modules 102 may be spaced apart in a linear fashion. Such an arrangement might occur, for example, when the modules 102 are being used by a group of motorcyclists travelling in a single file line. It may be the case that a first module 102a near the front of the pack is out of range with a fourth module 102d that is at the back of the pack. Nevertheless, the first module 102a and the fourth module 102d are still able to achieve full-duplex communication by relaying signals through the intermediate modules 102b, 102c.

Unlike a daisy-chain network, however, the system 300 is able to maintain connections or seamlessly re-establish connections even when a module 102 drops out of the network. For example, as shown in FIG. 4C, the fourth module 102d can be indirectly connected to the first module 102a and second module 102b through the third module 102c. In the event that the third module 102c drops out of communication (e.g., due to a dead battery or other reason), and assuming the fourth module 102d is within the second mode range of the second module 102b, the fourth module 102d can establish or maintain a direct connection with the second module 102b to continue the conversation.

In some examples, the modules 102 are configured to automatically connect with all stored modules 102 within range of the second mode, while capacity exists. For instance, in the situation where the fourth module 102d is within second mode range of both the second module 102b and the third module 102c, the fourth module 102d can connect to both the second module 102b and the third module 102c. Thus, in the event that the third module 102c drops out of communication, the fourth module 102d is still connected to the group via at least the second module 102b.

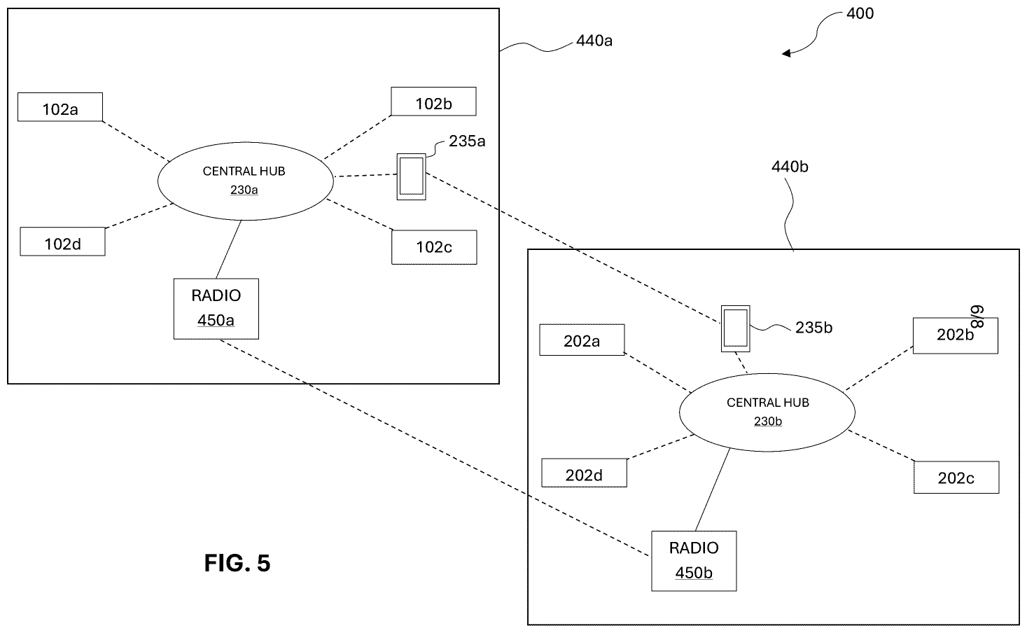

FIG. 5 illustrates a wireless communication system 400 including a first group or vehicle 440a and a second group or vehicle 440b having a first central hub 230a and a second central hub 230b, respectively, and a first auxiliary radio 450a and second auxiliary radio 450b, respectively. The system, modules, and central hubs described in FIG. 5 can be substantially similar to and can include some or all of the features of the systems, modules, and central hubs described above with respect to FIGS. 1-4. While only two groups are illustrated in FIG. 5, it will be understood that the system 400 is capable of operating with more than two groups (i.e., more than two central hubs and auxiliary radios). Further, while the groups 440a and 440b are described herein as vehicles, it will be understood that the system 400 is capable of operating in any multi-group setting, regardless of whether the groups are mobile or in vehicles. It will be understood that the communications of each vehicle 440a, 440b can operate independently and do not require the presence of a second communications network in order to provide the functionality described.

The first vehicle 440a can include a first central hub 230a and a first auxiliary radio 450a, either of which can be mounted to an interior or exterior of the first vehicle 440a. The first vehicle 440a can carry a first group of modules 102a-102d (referred to individually as module 102 and collectively as modules 102). The first group of modules 102 can be communicatively coupled to the first auxiliary radio 450a through the first central hub 230a. The first auxiliary radio 450a can be a “push-to-talk” (PTT) or two-way radio. Thus, while the modules 102 that are paired with the first central hub 230a can establish full-duplex communication with each other, communication over the first auxiliary radio 450a may be limited to half-duplex. In some examples, the first auxiliary radio 450a can include a General Mobile Radio Service (GMRS) radio, a Ham radio, a citizens band (CB) radio, or any other radio that operates over comparable open radio frequencies and can be capable of long-range communications over many miles. The first auxiliary radio 450a can be communicatively coupled, wired or wirelessly, with the first central hub 230a. Thus, each of the modules 102 can be wirelessly communicatively coupled to the auxiliary radio 450a through the central hub 230a. In some examples, the modules 102 can be wirelessly connected directly to the first auxiliary radio 450a.

The first auxiliary radio 450a can transmit signals from each module 102, regardless of which module initiated the radio transmission. For example, a first module 102a can include a PTT button that when actively actuated (i.e., pressed and held) initiates radio transmissions through the first auxiliary radio 450a. These transmissions can include audio signals from not only the initiating device (i.e., first module 102a), but from each module connected to the first central hub 230a (i.e., modules 102b-102d). In some examples, the first central hub 230a can include a PTT button that when pressed transmits the input audio from one or more of the modules 102. In some examples, the users are provided with an indicator or alert when the PTT button is pressed. For example, an audio indicator may be played through the users' speakers when one member of the group has pressed and/or released their PTT button.

When the PTT button is pressed on one of the modules 102, the module 102 signals to the first central hub 230a that transmission through the first auxiliary radio 450a is requested. This request prompts activation of auxiliary radio transmissions. Audio signals from the modules 102a-102d are then decoded by the first central hub 230a and mixed to a single audio stream and sent to the transmission path of the first auxiliary radio 450a. The first central hub 230a can mix voices from the modules 102a-102d to go out the transmit path of the first auxiliary radio 450a.

Accordingly, the first module 102a can open the auxiliary radio channel for all modules 102 connected to the first central hub 230a, despite the fact that the other users are not pressing the PTT button. A user pressing the PTT button can cause the central hub 230a to open a new channel with the first auxiliary radio 450a.

In some examples, the first central hub 230a only transmits audio signals from the module which initiated the radio transmission (i.e., pressed the PTT button). In other words, the system 400 may be programmed such that, in order for a module 102 to transmit through the auxiliary radio 450a, its PTT button must be actively engaged.

In some examples, only one module 102 at a time can transmit over the first auxiliary radio 450a. The first central hub 230a can include a priority protocol for establishing which module 102 has priority when multiple modules 102 are attempting to transmit over the first auxiliary radio 450a. In some examples, priority is given to whichever module 102 had its PTT button pressed first. In some examples, priority is given to whichever module 102 had its PTT button pressed most recently. In some examples, multiple modules 102 can simultaneously transmit over the first auxiliary radio 450a, but only those modules 102 whose PTT buttons are being actively pressed.

The first central hub 230a can be configured to receive audio transmissions received by the first auxiliary radio 450a from other auxiliary radios (e.g., second auxiliary radio 450b), and to disseminate those transmissions to one or more modules 102 of the first group of modules 102. In some examples, all of the modules 102 connected to the first central hub 230a can receive radio transmissions received by the first auxiliary radio 450a. In some examples, an operator of the first central hub 230a can select which modules 102 can communicate with the first auxiliary radio 450a (e.g., the first central hub 230a can be set to only allow a driver's module to receive and transmit signals via the first auxiliary radio 450a).

The modules 102 can be configured to operate having two or more channels open simultaneously. For example, the modules 102 can communicate with other proximate modules 102 and with first auxiliary radio 450a via the first central hub 230a, simultaneously. In other words, both the first mode channel and the auxiliary radio channel (third mode) can be open at the same time.

Thus, the first auxiliary radio 450a can provide another line of communication (e.g., a third mode) for each module 102 to communicate over long distances with a two-way radio tuned to the same frequency as the first auxiliary radio 450a. The modules 102 can be configured to automatically receive audio signals received by the first auxiliary radio 450a while the modules 102 are connected to the first central hub 230a in the first mode and while the first central hub 230a is connected to the first auxiliary radio 450a. In other words, modules in the first mode can automatically also operate in the third mode when an auxiliary radio is present in the system. In some examples, when the first module 102a is in the second mode, the PTT button to initiate two-way radio communication may be inoperable. In other words, the modules 102 may be required to be in the first mode in order to communicate via the first auxiliary radio 450a. In some examples, the modules 102 can communicate through the first auxiliary radio 450a in both the first mode and the second mode.

The second vehicle 440b can include a second central hub 230b and a second auxiliary radio 450b, either of which can be mounted to an interior or exterior the second vehicle 440b. The second vehicle 440b can carry a second group of modules 202a-202d (collectively 202). It will be understood that the second vehicle 440b, second central hub 230b, second group of modules 202, and second auxiliary radio 450b can be substantially similar to and can include some or all of the features of, the first vehicle 440a, the first central hub 230a, the first group of modules 102, and the first auxiliary radio 450a, respectively. Nevertheless, for the sake of completeness, a full recitation of the second vehicle 440b and its contents are provided below.

The second group of modules 202 can be communicatively coupled to the second auxiliary radio 450b through the second central hub 230b. The second auxiliary radio 450b can be a “push-to-talk” (PTT) or two-way radio. Thus, while the modules 202 that are paired with the second central hub 230b can establish full-duplex communication with each other, communication over the second auxiliary radio 450b may be limited to half-duplex. In some examples, the second auxiliary radio 450b can include a General Mobile Radio Service (GMRS) radio, a Ham radio, a citizens band (CB) radio, a VGC radio, or any other radio that operates over comparable open radio frequencies and can be capable of long-range communications over many miles. The second auxiliary radio 450b can be communicatively coupled, wired or wirelessly, with the second central hub 230b. Thus, each of the modules 202 can be wirelessly communicatively coupled to the auxiliary radio 450b through the central hub 230b. In some examples, the modules 202 can be wirelessly connected directly to the second auxiliary radio 450b.

The second auxiliary radio 450b can transmit signals from each module 202, regardless of which module 202 initiated the radio transmission. For example, a first module 202a can include a PTT button that when actively actuated (i.e., pressed and held) initiates radio transmissions through the second auxiliary radio 450b. These transmissions can include audio signals from not only the initiating device (i.e., first module 202a), but from each module connected to the second central hub 230b (i.e., modules 202b-202d). In some examples, the second central hub 230b can include a PTT button that when pressed transmits the audio input from one or more of the modules 202.

When the PTT button is pressed on one of the modules 202, the module 202 signals to the second central hub 230b that transmission through the second auxiliary radio 450b is requested. This request prompts activation of auxiliary radio transmissions. Audio signals from the modules 202a-202d are then decoded by the second central hub 230b and mixed to a single audio stream and sent to the transmission path of the second auxiliary radio 450b. The second central hub 230b can mix voices from the modules 202a-202d to go out the transmit path of the second auxiliary radio 450b.

Accordingly, the first module 202a can open a long-range radio channel for all modules 202 connected to the second central hub 230b despite the fact that the other users are not pressing the PTT button. A user pressing the PTT button can cause the second central hub 230b to open a new channel with the second auxiliary radio 450b.

In some examples, the second central hub 230b only transmits audio signals from the module which initiated the radio transmission (i.e., pressed the PTT button). In other words, the system 400 may be programmed such that, in order for a module 202 to transmit through the auxiliary radio 450b, its PTT button must be actively engaged.

In some examples, only one module 202 at a time can transmit over the second auxiliary radio 450b. The second central hub 230b can include a priority protocol for establishing which module 202 has priority when multiple modules 202 are attempting to transmit over the second auxiliary radio 450b. In some examples, priority is given to whichever module 202 had its PTT button pressed first. In some examples, priority is given to whichever module 202 had its PTT button pressed most recently. In some examples, multiple modules 202 can simultaneously transmit over the second auxiliary radio 450b, but only those modules 202 whose PTT buttons are being actively pressed.

The second central hub 230b can be configured to receive and transmit audio transmissions received by the second auxiliary radio 450b from other auxiliary radios (e.g., first auxiliary radio 450a), and to disseminate those transmissions to one or more modules 202 of the second group of modules 202. In some examples, all of the modules 202 connected to the second central hub 230b can receive radio transmissions received by the second auxiliary radio 450b. In some examples, an operator of the second central hub 230b can select which modules 202 can communicate with the second auxiliary radio 450b (e.g., the second central hub 230b can be set to only allow a driver's module to receive and transmit data via the second auxiliary radio 450b).

The modules 202 can be configured to operate having two or more channels open simultaneously. For example, the modules 202 can communicate with other proximate modules 202 and with the second auxiliary radio 450b via the second central hub 230b, simultaneously. In other words, both the first mode channel and the auxiliary radio channel (third mode) can be open at the same time.

Thus, the second auxiliary radio 450b can provide another line of communication (e.g., a third mode) for each module 202 to communicate over long distances with a two-way radio tuned to the same frequency as the second auxiliary radio 450b. The modules 202 can be configured to automatically receive audio signals received by the second auxiliary radio 450b while the modules 202 are connected to the second central hub 230b in the first mode and while the second central hub 230b is connected to the second auxiliary radio 450b. In some examples, when the second module 202b is in the second mode, the PTT button to initiate two-way radio communication may be inoperable. In other words, the modules 202 may be required to be in the first mode in order to communicate via the second auxiliary radio 450b. In some examples, the modules 202 can communicate through the second auxiliary radio 450b in both the first mode and the second mode.

As a non-limiting embodiment of an example operation of the system 400, a user of the first module 102a may be a passenger in the first vehicle 440a. In the first mode, the passenger can communicate, in full-duplex with the other passengers carrying modules 102b-102d. The passenger can also communicate with the passengers of the second vehicle 440b by pressing the PTT button on the first module 102a. With the PTT button pressed, the second group of modules 202a-202d can receive audio from each of the modules of the first group of modules 102a-102d. Likewise, when radio transmissions are sent from the second auxiliary radio 450b to the first auxiliary radio 450a, every module 102a-102d can receive through their speaker(s) the audio received by the first auxiliary radio 450a. While a PTT button is pressed on the first module 102a, thereby activating the third mode, the remaining modules 102b-102d in the vehicle 440a can still hear the audio from the first module 102a through the first mode channel, and likewise, the first module 102a can still hear the audio from the other passengers 102b-102d even when the PTT button on the first module 102a is depressed.

In some examples, a full-duplex cellular communication between the users of each vehicle 440a, 440b can be facilitated by the system 400. A first electronic device 235a can be wirelessly connected to the first central hub 230a. Likewise, a second electronic device 235b can be wirelessly connected to the second central hub 230b. When cellular service is available, users can initiate a cellular telephone conversation between the first electronic device 235a and the second electronic device 235b, and because the devices 235a, 235b are paired with the first and second central hubs 230a, 230b respectively, those modules 102 that are connected with the respective central hub 230a, 230b can participate in the telephone conversation in full-duplex. It will be understood that the modules and central hubs described herein are capable of operating according to one or more of systems 100, 200, 300 and 400, and in some cases can operating according to multiple systems simultaneously.

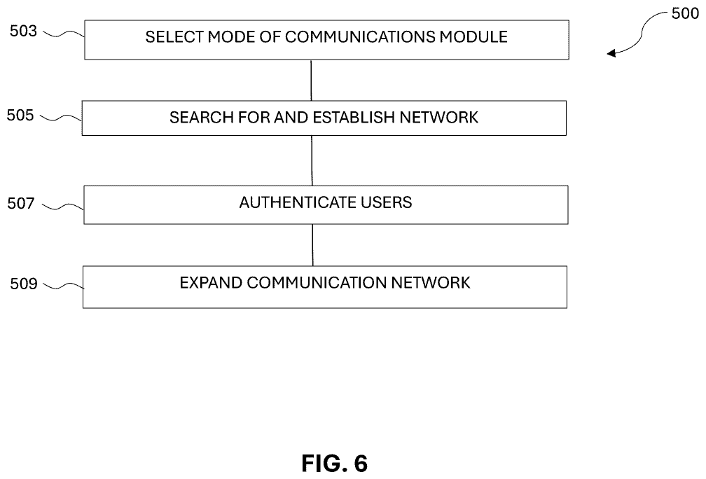

FIG. 6 illustrates a process flow diagram 500 describing example operations of the communication systems described herein. At step 503 a mode is selected on or by a communications module. In some examples, the modules can include a switch, button, slider, toggle, actuator or any other type of input member that can be selected by the user to change modes (hereinafter referred to as the “mode switch”). The mode switch can be on an exterior of the module housing, such that is accessible to a user handling the housing. In some examples, the mode switch can be located on the back of the housing of the module (i.e., the surface that resides adjacent the major surface of the mount), in which case use of such a mode switch may involve removing the module from a mount or cradle in order to access the mode switch. In this manner, the mode switch can be protected from being accidentally changed. In some examples, the mode can be changed through a mobile electronic device that is paired with the module (i.e., through a smartphone application). In some examples, the central hub includes a mode switch to change modes of one or more paired modules. In some examples, the central hub can include interface controls to allow a user to select specific modules to be in certain modes.

In some examples, the mode switch can be continuously depressed in order to enter and remain in the second mode, and upon releasing the mode switch the module reverts to the first mode. In this manner, the mode switch can operate as a push-to-talk (PTT) input that allows the user to selectively jump between conversations in the first mode with a first group of users and conversations in the second mode with a second group of users.

The modules can be configured to selectively or automatically change modes. Upon changing from the first mode to the second mode, a module may disconnect from the central hub and initiate a new protocol to establish a connection with other modules that are in the second mode. In this manner, the module is able to perform in a close-range environment, such as between passengers of a vehicle, and a long-range environment, such as between different vehicles.

In some examples, switching between modes can be done automatically based on a determination made by a processor or controller of the module. In some examples, the mode switch can be used to override an automatic setting which automatically determined which mode to be in. The mode switch can include three options or positions: first mode, second mode, and an automatic mode. The automatic mode can change between modes based on determined parameters without the need for user input. In some examples, upon reaching a certain threshold (e.g., signal strength), the module automatically changes modes for best performance. In some examples, the module automatically changes from the second mode to the first mode when battery level drops below a predetermined threshold.

The module can produce a visual, audible, and/or tactile feedback to the user when modes have been changed. For example, upon changing modes the module can produce an audio signal to be output through a speaker, a visual indicator such as a flashing light on the exterior of the module, or a banner displayed on the mobile app, and/or a click, vibration or other tactile feedback to inform the user that the mode was changed.

In some examples, users in a group can communicate in the second mode while being proximate to one another (i.e., the modules can communicate in the second mode even when proximate enough for the first mode). In some examples, the system can detect or determine that the modules are proximate enough to communicate via the first mode and can automatically switch from the second mode to the first mode. The device can coordinate a simultaneous change in order to produce a seamless exchange with minimal interruption to the conversation.

At step 505, the module and/or central hub can search for and establish a communications network. In the second mode, a module that is connected to the maximum number of connections will continue to scan and advertise to discover isolated devices as part of the network self-healing functionality. In some examples, each module tracks and shares information on all of the other modules with which it is connected.

At step 507, the module and/or central hub can authenticate the users trying to join or establish a network, and at step 509 the communication network can be expanded. The modules can be provided a predefined universally unique identifier (UUID) that is shared during the pairing process. In the first mode, the UUID for the central hub is known by the modules, and the modules advertise using that specific UUID. After a module is connected to the central hub, there is an authentication step in which an authentication key is provided to verify the correct connection. The second mode utilizes a different set of UUIDs, such that only those modules with the second mode UUID and authentication key can join a connection network between other modules.

In the first mode, the central hub can scan to find modules and make connections to those modules that have the correct UUID. In second mode all modules can scan and advertise so each module can initiate a connection with other modules. For example, when a first module detects a second module, the first module can look in its current group list to see if the second module is in the group. If the second module is not located in the group list of the first module, and if the second module is advertising with the correct UUID(s), the first module will initiate a connection with the second module. Immediately after establishing the connection the two modules will authenticate each other using the group authentication key.

The system does not create its own timeslots (or TDMA) system. Instead, using Bluetooth low energy (BLE) standard for the communication physical channel which uses its frequency hopping and timeslot management system. The systems described herein can be both a frequency division multiple access (FDMA) and a time division multiple access (TDMA) system.

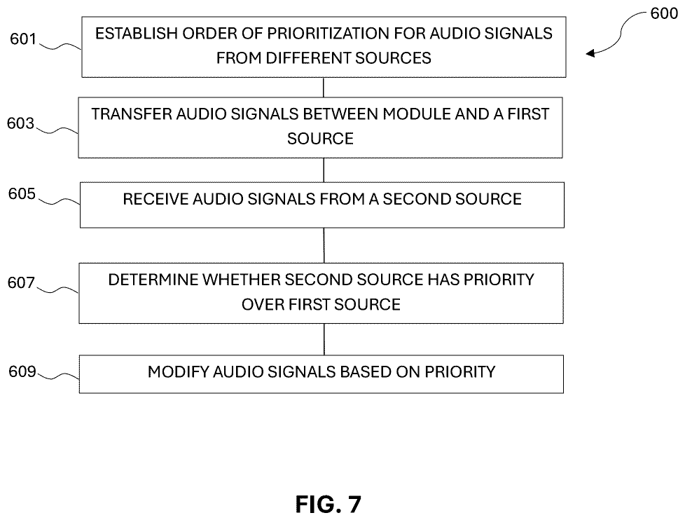

FIG. 7 illustrates a process flow diagram 600 of an example prioritization system. The module and/or central hub can include a processor or controller programmed to prioritize various functions or devices. For the purposes of this application, to prioritize audio content or data refers to establishing protocols for how audio signals are modified, particularly when there is competing audio signals. Such prioritization can include preventing audio input into the communications module from being transmitted by the radio and preventing signals received by the radio from being output by the communications module, to the user of the communications module. Prioritization can also refer to modifying the volume of audio signals. Such prioritization can include increasing or decreasing a volume of some audio signals relative to others (e.g., decreasing the volume of audio signals received from other modules, the hub, or electronic device, and/or increasing the volume of audio signals received by the radio).

At step 601, an order of prioritization for audio signals or content from different sources can be established. This order can be predetermined or hardwired as a default setting in the module and/or central hub. In some examples, the prioritization order can be customized by the user.

At step 603, audio signals can be transferred between a module and a first source. For example, a module may be receiving music from the central hub. At step 605 the module can receive audio signals from a second source. For example, the module may receive communication from another module or from the auxiliary radio. At step 607, the processor (of the module or of the central hub) determines which source has priority, and at step 607, the processor modifies one or more of the audio signals based on the priority.

For example, the user can conduct a mobile telephone conversation via the module. The controller can identify the answered cellular phone call and can prioritize that conversation over transmissions from other modules or transmissions from an auxiliary radio. As another example, the controller of the module can prioritize audio content (e.g., music) from a paired personal electronic device over music transmitted over the central hub or another module. In some examples, the module can prioritize one channel over another. For example, the module can prioritize the auxiliary radio channel over the first mode channel, or vice versa. In some examples, a processor or controller of the central hub can perform prioritization protocols.

In some examples, the wireless communication system may include plurality of nodes. One node of the plurality of nodes of the wireless communication system may comprise a central unit and one or more nodes of the plurality of nodes may comprise communications modules and/or intercoms. In such an embodiment, the radio of a communications module and/or an intercom may communicate with the radio of another communications module and/or intercom through the central unit. The central unit may also broadcast music and/or phone operations to the radio(s) of one or more communications modules and/or intercoms.

Other aspects of the disclosed subject matter, as well as features and advantages of various aspects of the disclosed subject matter, should be apparent to those of ordinary skill in the art through consideration of the preceding disclosure, the ensuing description, the accompanying drawings, and the appended claims.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A communications module for facilitating mobile wireless communication, the communications module comprising:
a transceiver configured to enable wireless communication;
a processor communicatively coupled to the transceiver;
a mode switch configured to change an operating setting of the communications module between a first mode and a second mode;
wherein:
in the first mode, the transceiver is configured to communicate with a central communications unit; and
in the second mode, the transceiver is configured to communicate with a corresponding communications module.

2. The communications module of claim 1, wherein the mode switch is selectable by a user.

3. The communications module of claim 1, further comprising an input member configured to enable audio signals from the communications module to be transmitted through an auxiliary radio.

4. The communications module of claim 3, wherein the auxiliary radio is communicatively coupled to the central communications unit and wherein the audio signals are transmitted through the central communications unit to the auxiliary radio.

5. The communications module of claim 4, wherein the transceiver is configured to receive transmissions from the auxiliary radio through the central communications unit.

6. The communications module of claim 5, wherein, in the first mode, the communications module is configured to simultaneously communicate with the corresponding communications module and with the auxiliary radio.

7. The communications module of claim 1, further comprising a push-to-talk (PTT button) configured to transmit audio output from a microphone connected to the communications module through an auxiliary radio.

8. The communications module of claim 1, wherein:
the first mode enables full-duplex communication between the communications module and the central communications unit; and
the second mode enables full-duplex communication between the communications module and the corresponding communications module.

9. The communications module of claim 1, wherein:
in the first mode, the transceiver operates at a first power;
in the second mode, the transceiver operates at a second power; and
the second power is greater than the first power.

10. The communications module of claim 1, wherein the transceiver is a first transceiver, the communications module further comprising a second transceiver configured to establish wireless communication with a mobile electronic device.

11. The communications module of claim 10, wherein the first transceiver is configured to operate according to Bluetooth LE, and the second transceiver is configured to operate according to Bluetooth classic.

12. A communication system, comprising:
a central hub configured to communicatively couple with an auxiliary radio capable of long range two-way communication;
a first mobile intercom configured to be carried by a first user, the first mobile intercom comprising:
a first output terminal configured to connect to a first speaker;
a first input terminal configured to connect to a first microphone;
a first wireless communications unit configured to establish wireless communication between the first mobile intercom and the central hub; and
a first input member configured to receive user input; and
a second mobile intercom configured to be carried by a second user, the second mobile intercom comprising:
a second output terminal configured to connect to a second speaker;
a second input terminal configured to connect to a second microphone;
a second wireless communications unit configured to establish wireless communication between the second mobile intercom and the central hub; and
a second input member configured to receive user input;
wherein, in response to receiving user input at the first input member, the central hub transmits audio signals received by the first microphone and the second microphone through the auxiliary radio.

13. The communication system of claim 12, wherein the first input member comprises push-to-talk (PTT) functionality and wherein the audio signals received by the first microphone or the second microphone are transmitted through the auxiliary radio while the first input member is actuated.

14. The communication system of claim 12, wherein the central hub is configured to:
communicatively couple with a plurality of mobile intercoms;
transmit audio output from the auxiliary radio to each of the plurality of mobile intercoms; and
in response to receiving user input at the first input member, transmit audio input from each of the plurality of intercoms through the auxiliary radio.

15. The communication system of claim 12, wherein the central hub prioritizes audio signals from the auxiliary radio over audio content from a personal electronic device paired with the first mobile intercom.

16. The communication system of claim 12, wherein the first mobile intercom prioritizes audio from a telephone call from a paired personal electronic device over audio from the auxiliary radio.

17. A mobile communication system, comprising:
a first intercom device configured to be carried by a first user;
a second intercom device configured to be carried by a second user; and
a base station comprising:
a wireless communications unit configured to:
establish a wireless connection with an electronic device; and
enable full-duplex communication between the first intercom device and the second intercom device;
wherein the base station is configured to share audio content from the electronic device with the first intercom device and the second intercom device while maintaining the full-duplex communication between the first intercom device and the second intercom device.

18. The mobile communication system of claim 17, wherein the wireless communications unit comprises:
a first wireless communications chip configured to enable wireless communication with the first intercom device and the second intercom device; and
a second wireless communications chip configured to enable wireless communication between the base station and the electronic device.

19. The mobile communication system of claim 17, wherein:
the electronic device is a first electronic device; and
the second intercom device is configured to wirelessly pair with a second electronic device and to prioritize audio content from the second electronic device over audio content from the first electronic device.

20. The mobile communications system of claim 19, wherein the second intercom device is configured to prioritize audio signals transmitted through the base station from the first intercom device over audio content from the second electronic device.
